(19) United States
(12) Patent Application Publication
(10) Pub. No.: US 2019/0282445 A1
(43) Pub. Date: Sep. 19, 2019

(54) PORTABLE TEMPERATURE-STABLE STORAGE DEVICE

(71) Applicant: IDEABATIC LTD, Trumpington, Cambridgeshire (GB)

(72) Inventors: Kitty Chia-Chi LIAO, Trumpington (GB); David BATEMAN, London (GB); Adam ALEXANDER, Trumpington (GB)

(21) Appl. No.: 16/349,973

(22) PCT Filed: Nov. 14, 2017
(86) PCT No.: PCT/GB2017/053425

§ 371 Date: May 14, 2019

(30) Foreign Application Priority Data
Nov. 14, 2016 (GB) 1619273.4

(51) Int. Cl. A61J 1/16; F25D 11/02; F25D 23/02; F25D 25/04

(52) U.S. Cl. CPC A61J 1/165; F25D 11/02; F25D 23/025; A61J 2200/70; F25D 2700/06; F25D 2600/04; A61J 2200/44; F25D 25/04

(57) ABSTRACT

A portable temperature-stable storage device for at least one object, the portable temperature-stable storage device comprising: a primary chamber (100) configured to store the at least one object; a secondary chamber (120) comprising: a first barrier (121) configured to, in an open configuration, provide access from external surroundings of the portable temperature-stable storage device to inside the secondary chamber and, in a closed configuration, prevent access from external surroundings of the portable temperature-stable storage device to inside the secondary chamber, and a second barrier (122) configured to, in an open configuration, provide access from the secondary chamber to the primary chamber and, in a closed configuration, prevent access from the secondary chamber to the primary chamber; and wherein the second barrier is adjustable between the open configuration and the closed configuration whilst the first barrier is in the closed configuration.

### TECHNOLOGICAL FIELD

Embodiments of the present invention relate to a portable temperature-stable storage device. Certain embodiments relate to a portable low-temperature storage device for storing temperature-sensitive pharmaceutical products.

### BACKGROUND

Temperature-sensitive objects degrade outside of an allowable temperature range. Temperature-sensitive objects must sometimes be transported from facilities which provide temperature-controlled environments to recipients. During the transportation the temperature of the temperature-sensitive objects must be maintained within the allowable temperature range to prevent degradation occurring.

One example of temperature-sensitive objects are vaccines. According to World Health Organisation (VVHO), two to three million children die every year due to a vaccine-preventable disease and, in 2015, an estimated 19.4 million infants were not reached by routine immunisation services worldwide.

Many vaccines are degraded (e.g., spoiled such that they cannot be administered) during the final journey from local medical centres or vaccine storages to the final recipients (e.g., the patients). Vaccines are required to be stored between 2° C. and 8° C. to prevent degradation (in accordance with WHO standards). In some cases these final journeys, sometimes referred to as the ‘last mile’, may take 5 to 7 days or more. A portable storage device capable of reliably maintaining a stable low-temperature for this period of time is therefore required.

### BRIEF SUMMARY

Aspects and embodiments of the present disclosure provide a portable temperature-stable storage device and a system as claimed in the appended claims.

According to a first aspect of the present disclosure there is provided a portable temperature-stable storage device for at least one object, the portable temperature-stable storage device comprising: a primary chamber configured to store the at least one object; a secondary chamber comprising: a first barrier configured to, in an open configuration, provide access from external surroundings of the portable temperature-stable storage device to inside the secondary chamber and, in a closed configuration, prevent access from external surroundings of the portable temperature-stable storage device to inside the secondary chamber, and a second barrier configured to, in an open configuration, provide access from the secondary chamber to the primary chamber and, in a closed configuration, prevent access from the secondary chamber to the primary chamber; and wherein the second barrier is adjustable between the open configuration and the closed configuration whilst the first barrier is in the closed configuration.

According to various, but not necessarily all, examples of the present disclosure access to the primary chamber via the secondary chamber is for conveyance of the at least one object between the external surroundings of the portable temperature-stable storage device and the primary chamber.

According to various, but not necessarily all, examples of the present disclosure the portable temperature-stable storage device further comprises a fluid removal means configured to remove at least some of the fluid from the secondary chamber and/or primary chamber.

According to various, but not necessarily all, examples of the present disclosure the fluid removal means comprises: at least one valve disposed between the secondary chamber and the external surroundings; and a moveable means, disposed within the secondary chamber, configured such that movement of the moveable means with respect to the at least one valve causes transfer of fluid through the at least one valve.

According to various, but not necessarily all, examples of the present disclosure the at least one valve is a one-way valve configured to enable fluid to flow from inside the secondary chamber to the external surroundings and prevent fluid from flowing from the external surroundings to inside the secondary chamber.

According to various, but not necessarily all, examples of the present disclosure the at least one valve is disposed adjacent the second barrier.

According to various, but not necessarily all, examples of the present disclosure the moveable means comprises a moveable platform which extends substantially across a cross section of the secondary chamber parallel to the second barrier.

According to various, but not necessarily all, examples of the present disclosure the moveable means forms a moveable fluid-tight seal with the walls of the secondary chamber.

According to various, but not necessarily all, examples of the present disclosure the second barrier is manually adjustable between the open configuration and the closed configuration.

According to various, but not necessarily all, examples of the present disclosure the second barrier is automatically controlled between the open configuration and the closed configuration.

According to various, but not necessarily all, examples of the present disclosure the portable temperature-stable storage device further comprises a sensor configured to detect the presence of an object in the secondary chamber.

According to various, but not necessarily all, examples of the present disclosure the second barrier is controlled to switch between the open configuration and the closed configuration in response to detection of an object in the secondary chamber.

According to various, but not necessarily all, examples of the present disclosure access to the primary chamber is solely via the secondary chamber.

According to various, but not necessarily all, examples of the present disclosure the portable temperature-stable storage device further comprises a third barrier configured to, in an open configuration, provide access from external surroundings of the portable temperature-stable storage device to inside the primary chamber and, in a closed configuration, prevent access from external surroundings of the portable temperature-stable storage device to inside the primary chamber.

According to various, but not necessarily all, examples of the present disclosure the portable temperature-stable storage device further comprises a further secondary chamber comprising: a fourth barrier configured to, in an open configuration, provide access from external surroundings of the portable temperature-stable storage device to inside the further secondary chamber and, in a closed configuration, prevent access from external surroundings of the portable temperature-stable storage device to inside the further secondary chamber; and a fifth barrier configured to, in an open configuration, provide access from the further secondary chamber to the primary chamber and, in a closed configuration, prevent access from the further secondary chamber to the primary chamber, and wherein access to the primary chamber via the secondary chamber is for one of loading or dispensing the at least one object and access to the primary chamber via the further secondary chamber is for the other of dispensing or loading the at least one object.

According to various, but not necessarily all, examples of the present disclosure the primary chamber comprises one or more storage compartments for the at least one object.

According to various, but not necessarily all, examples of the present disclosure the primary chamber comprises means for conveying the at least one object to and/or from a storage compartment.

According to various, but not necessarily all, examples of the present disclosure the primary chamber is configured to be maintained within an allowable temperature range.

According to various, but not necessarily all, examples of the present disclosure the secondary chamber is formed integrally with the primary chamber.

According to various, but not necessarily all, examples of the present disclosure the secondary chamber, comprising the first barrier and the second barrier, is configured to decouple from the portable temperature-stable storage device.

According to various, but not necessarily all, examples of the present disclosure the secondary chamber comprises a plurality of compartments each configured to store at least one object.

According to various, but not necessarily all, examples of the present disclosure the second barrier comprises a plurality of barriers, wherein each of the plurality of barriers is configured as an adjustable barrier for each compartment.

According to various, but not necessarily all, examples of the present disclosure the portable temperature-stable storage device is a portable low-temperature storage device.

According to various, but not necessarily all, examples of the present disclosure the portable temperature-stable storage device is for storing at least one temperature-sensitive pharmaceutical product.

According to another aspect of the present disclosure there is provided a system comprising: the portable temperature-stable storage device of any preceding claim; and a container configured to store at least one object wherein the container comprises one or more adjustable barriers configured to, in a closed configuration, separate the at least one object and the secondary chamber of the portable temperature-stable storage device and, in an open configuration, release the objects from the container.

According to various, but not necessarily all, embodiments of the invention there is provided examples as claimed in the appended claims.

### BRIEF DESCRIPTION

For a better understanding of various examples that are useful for understanding the detailed description, reference will now be made by way of example only to the accompanying drawings in which:

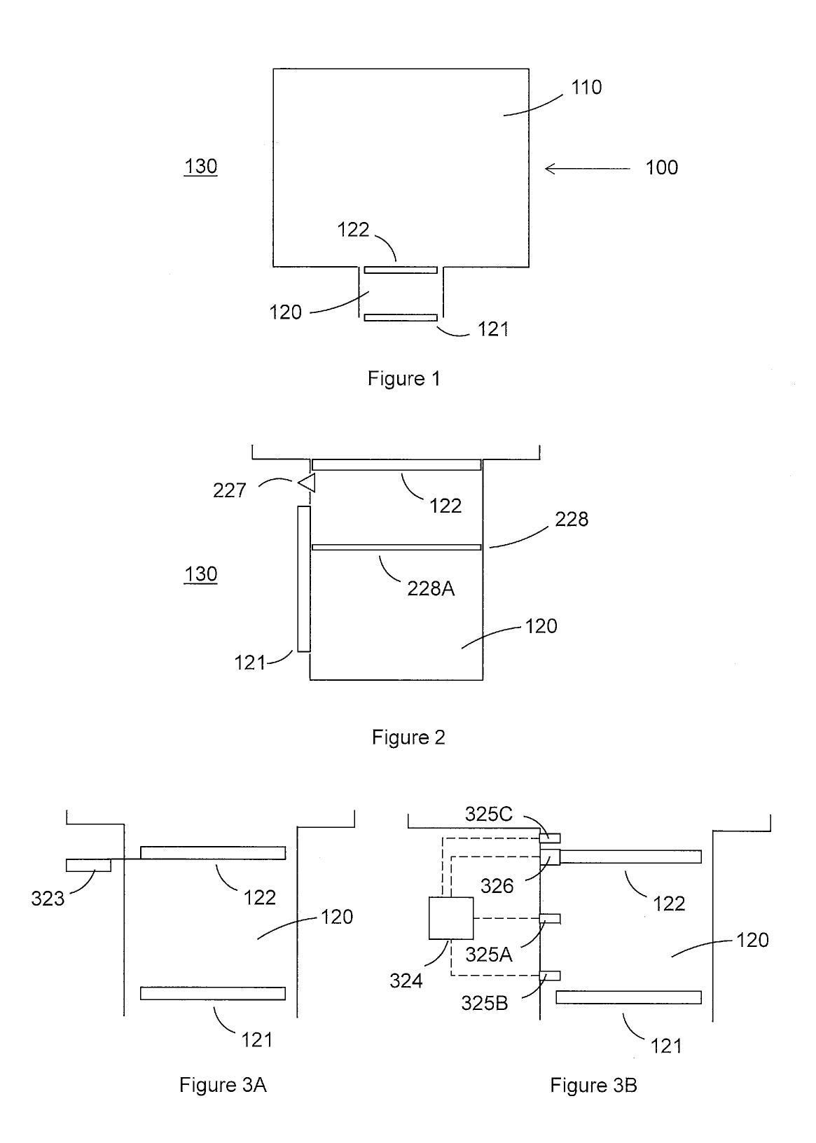

FIG. 1 schematically illustrates an example of a cross-section of a portable low-temperature storage device;

FIG. 2 schematically illustrates an example of a fluid removal means in a secondary chamber of a portable low-temperature storage device;

FIGS. 3A and 3B schematically illustrate examples of a cross-section of a secondary chamber of a portable low-temperature storage device;

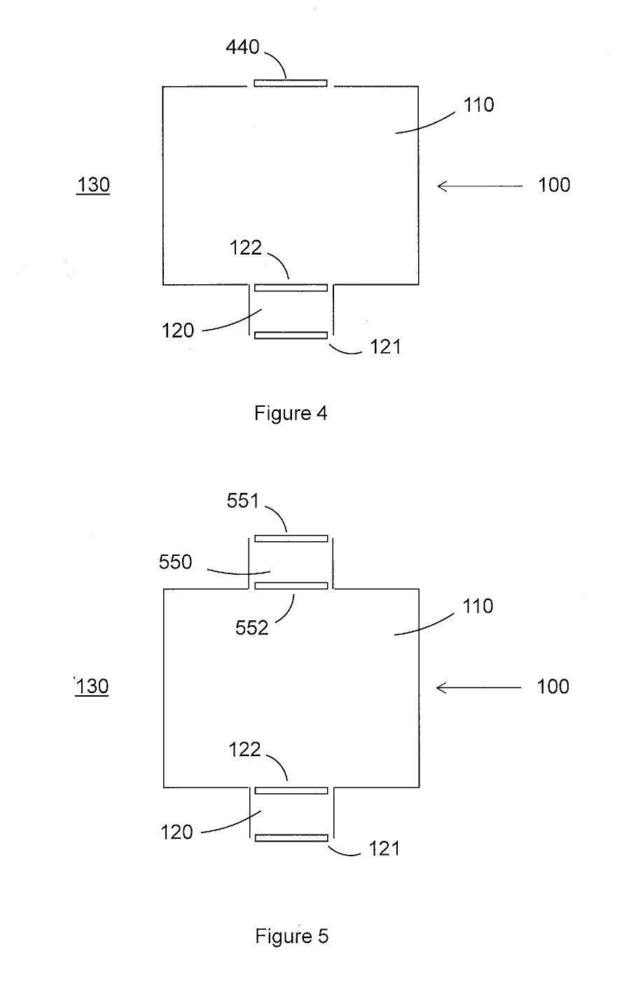

FIG. 4 schematically illustrates an example of a cross-section of a portable low-temperature storage device;

FIG. 5 schematically illustrates an example of a cross-section of a portable low-temperature storage device;

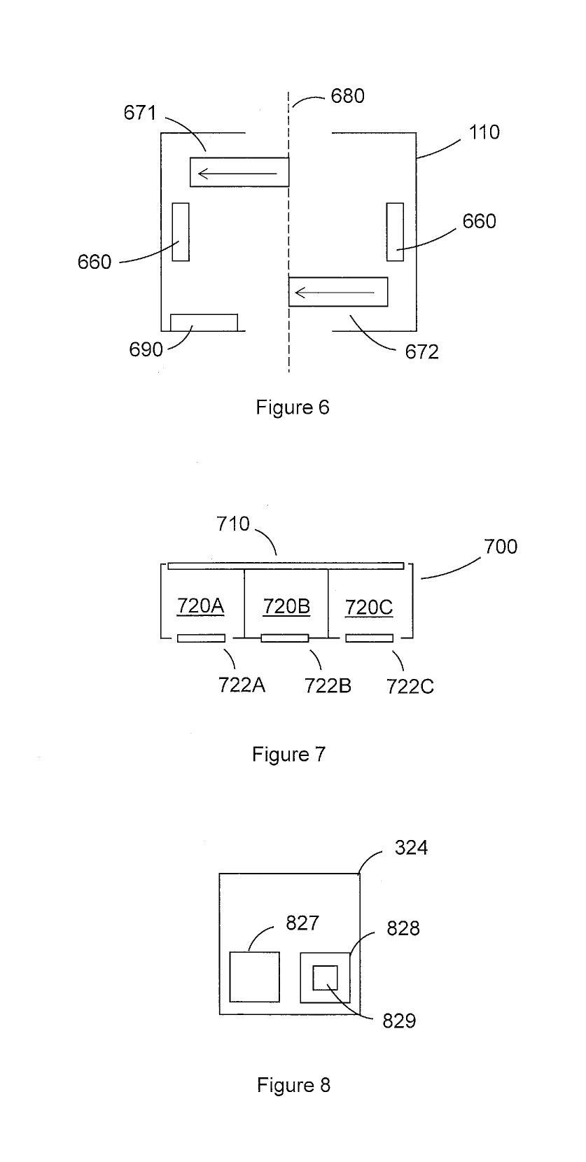

FIG. 6 schematically illustrates an example of a cross-section of a primary chamber of a portable low-temperature storage device;

FIG. 7 schematically illustrates an example of a container; and

FIG. 8 schematically illustrates an example of a controller.

### DETAILED DESCRIPTION

The figures illustrate an example of a portable temperature-stable storage device 100 for storing at least one object. The portable temperature-stable storage device 100 comprises a primary chamber 110 configured to store the at least one object and a secondary chamber 120. The secondary chamber 120 comprises a first barrier 121 and a second barrier 122. The first barrier 121 is configured to, in an open configuration, provide access from external surroundings 130 of the portable temperature-stable storage device 100 to inside the secondary chamber 120 and, in a closed configuration, prevent access from external surroundings 130 of the portable temperature-stable storage device 100 to inside the secondary chamber 120. The second barrier 122 is configured to, in an open configuration, provide access from the secondary chamber 120 to the primary chamber 110 and, in a closed configuration, prevent access from the secondary chamber 120 to the primary chamber 110. The second barrier 122 is configurable in the open configuration and the closed configuration whilst the first barrier 121 is in the closed configuration. By the term ‘temperature-stable’, it is meant that the portable storage device 100 is configured to maintain a substantially stable temperature within the chamber in which the temperature-sensitive objects are stored (e.g., the primary chamber 110).

By the term ‘portable’, it is meant that the low-temperature storage device 100 is capable of being transported by people travelling on foot or by, for example, bikes, donkeys, canoes, drones, etc.

In certain embodiments, as herein described, the portable temperature-stable storage device 100 is a portable low-temperature storage device. The term ‘low-temperature’ refers to, for example, temperatures lower than 5° C. or lower than 10° C. or lower than 15° C. or lower than 20° C. In some examples the term ‘low-temperature’ refers to, for example, temperatures lower than the ambient air temperature (e.g., the temperature of the external surroundings). Similarly, it would be understood that the term ‘high-temperature’ refers to, for example, temperatures above 20° C. or above 30° C. or above the ambient air temperature.

In certain embodiments, as herein described, the one or more objects for which the primary chamber 110 is configured to store are temperature-sensitive pharmaceutical products. Pharmaceutical products may comprise medical, surgical, dental and veterinary products including, for example, medicaments, vaccines, blood, organs, etc.

As illustrated in FIG. 1, which shows an example of a cross-section of a portable low-temperature storage device 100, the first barrier 121 and second barrier 122 of the second chamber 120 permit the conveyance of objects between the external surroundings 130 of the portable low-temperature storage device 100 (e.g., the environment) and the primary chamber 110. The first barrier 121 and second barrier 122 are provided in series. The first barrier 121, in the open configuration, permits an object to be conveyed between the secondary chamber 120 and the environment.

For example, when the first barrier 121 is in the open configuration, an object may be placed within the second chamber from outside the portable low-temperature storage device 100. In the closed configuration, the first barrier 121 seals the object inside the portable low-temperature storage device 100 and convective heat transfer between the secondary chamber 120 and the environment is reduced. The second barrier 122, in the open configuration, permits an object to be conveyed between the secondary chamber 120 and the primary chamber 110. In the closed configuration, the second barrier 122 seals the primary chamber 110 against the secondary chamber 120 and convective heat transfer between the secondary chamber 120 and the primary chamber 110 is reduced. When the first barrier 121 is in the open configuration, holding the second barrier 122 in the closed configuration seals the primary chamber 110 against the environment and reduces convective heat transfer therebetween.

The first barrier 121 and second barrier 122 are configured such that they are not able to be held in the open configuration simultaneously. Therefore in conveying an object from outside the portable low-temperature storage device 100 to the primary chamber 110, where the object may be stored, the object is first placed in the secondary chamber 120, which is separated from the primary chamber 110 by the second barrier 122 held in the closed configuration. The secondary chamber 120 is then sealed against the environment by adjusting the first barrier 121 to the closed configuration and the second barrier 122 is adjusted to the open configuration to permit conveyance of the object from the secondary chamber 120 to the primary chamber 110.

Similarly, in conveying an object from the primary chamber 110 to outside the portable low-temperature storage device 100, the object is conveyed into the secondary chamber 120, which is separated from the environment by the first barrier 121 held in the closed configuration. The primary chamber 110 is then sealed against the secondary chamber 120 containing the object by adjusting the second barrier 122 to the closed configuration and the first barrier 121 is adjusted to the open configuration to permit conveyance of the object from the secondary chamber 120 to outside the portable low-temperature storage device 100.

The secondary chamber 120 therefore enables reduction of the heat transfer between the environment and the primary chamber 110, particularly when loading or dispensing objects to or from the portable low-temperature storage device 100. As such, less energy is required to maintain a substantially stable temperature within the chamber in which the objects (e.g., temperature-sensitive pharmaceutical products) are stored (e.g., the primary chamber 110).

By the term ‘substantially stable’, it is meant that the temperature is maintained within an allowable range of temperatures such that temperature-sensitive objects stored within the primary chamber 110 are not degraded (e.g., damaged or rendered insufficient for their intended purpose or for consumption). The allowable range of temperatures is therefore dependent on the nature of the temperature-sensitive object to be stored by the portable low-temperature storage device 100. In some examples, the allowable range is 5° C. either side of an optimal temperature for storing the temperature-sensitive object. In some examples, the allowable range is narrow and may be, for example, 4, 3, 2, or 1° C., etc. either side of an optimal temperature. In some examples the allowable range may not be symmetric about the optimal temperature. In examples where the objects to be stored are vials of vaccines, the allowable temperature range is between 2° C. and 8° C. Outside of this range the vaccines may become degraded such that they cannot be administered to patients.

Although it is previously described that the first barrier 121 and second barrier 122 are configured such that they are not able to be held in the open configuration simultaneously, in some examples, they are configured to be able to be simultaneously held in the open configuration to facilitate more rapid loading or dispensing of multiple objects to or from the primary chamber 110.

In some examples, in the closed configuration, the first barrier 121 and second barrier 122 provide hermetic seals. The portable low-temperature storage device 100 further comprises a means configured to remove fluid such as air from the secondary chamber 120 such as, for example, a vacuum pump or a suction pump or a valve for use with the same (i.e., it is to be appreciated that the portable low-temperature storage device may not comprise a pump itself but is configured, by means of said valve, for use with a separately provided pump) or a fan or an exhaust or ventilation system. Since air from the environment will fill the secondary chamber 120 when an object is conveyed into the secondary chamber 120 from outside the portable low-temperature storage device 100 and this air may have a temperature outside the allowable temperature range (or even merely a higher or lower temperature than the temperature inside the primary chamber 110), removing this air before the second barrier 122 is adjusted to the open configuration to allow conveyance of the object into the primary chamber 110 will improve the stability of the temperature in the primary chamber 110. When the second barrier 122 is in an open configuration the air removal means may also remove air from the primary chamber 110.

Similarly, in some examples, in the closed configuration, the first barrier 121 and second barrier 122 provide leak-tight seals. The portable low-temperature storage device 100 further comprises a means configured to remove moisture from the secondary chamber 120 such as, for example, a vacuum pump or a suction pump or a valve for use with the same, or a fan or an exhaust or ventilation system. The means configured to remove air may be the same as the means configured to remove moisture.

FIG. 2 illustrates an example of a fluid removal means comprising at least one valve 227 disposed between the secondary chamber 120 and the external surroundings 130 and further comprising a moveable means 228, disposed within the secondary chamber 120, configured such that movement of the moveable means 228 with respect to the at least one valve 227 causes transfer of fluid through the at least one valve 227. When the moveable means 228 moves towards the at least one valve 227 it urges fluid through the valve 227.

In the example of FIG. 2 the first barrier 121 is at least substantially perpendicular (including perpendicular) to the second barrier 122. The secondary chamber 120 comprises a first valve 227 disposed in the wall of the secondary chamber 120. The first valve 227 is a first one-way valve (e.g., a reed valve) which is disposed proximate the second barrier 122 in the secondary chamber 120. For example the first one-way valve 227 is disposed adjacent the second barrier 122. The first one-way valve 227 is configured to enable fluid (e.g., gas such as air that enters the secondary chamber 120 from the external surroundings 130) to flow from inside the secondary chamber 120 to the external surroundings 130 but prevent fluid from flowing from the external surroundings 130 to inside the secondary chamber 120.

In the example of FIG. 2 the secondary chamber 120 also comprises a moveable means 228 disposed therein. In some examples the movable means 228 comprises a moveable platform 228A. The moveable platform 228A extends substantially across a cross section of the secondary chamber 120 parallel to the second barrier 122. In some examples the moveable means 228 sealingly engages the walls of the secondary chamber 120 to form a moveable hermetic or fluid-tight (e.g., gas tight) seal. For example the moveable means 228 further comprises a sealing ring which circumscribes the perimeter of the moveable platform 228A to form a moveable fluid-tight seal with the walls of the secondary chamber 120. The moveable means 228 may be moved towards and away from the second barrier 122.

When an object is dispensed from the primary chamber 110 into the secondary chamber 120 the second barrier 122 is subsequently adjusted to a closed configuration and the first barrier 121 is adjusted to the open configuration in order to enable the object to be removed from inside the secondary chamber 120 (to the external surroundings 130). When the first barrier 121 is in the open configuration air enters the secondary chamber 120 from the external surroundings 130. This air is may be above or below the allowable temperature range for storing the objects in the primary chamber 110. Once the first barrier 121 is adjusted to the closed configuration this air is sealed inside the secondary chamber 120. It may be desirable to remove this air from the secondary chamber 120 before adjusting the second barrier 122 to the open configuration (to facilitate the dispensing of another object from the primary chamber 110 and subsequently the portable low-temperature storage device 100) so that this air does not enter the primary chamber 110 and thus affect the temperature therein.

When the first barrier 121 is adjusted to the open configuration the moveable means 228 is moved to a position which is substantially the same distance (or further) from the second barrier 122 as the edge of the first barrier 121 that is furthest from the second barrier 122. This enables the object to be easily removed from the secondary chamber 120 (to the external environment 130). It is to be appreciated that the moveable means 228 may have any position that enables the object to fit entirely in the secondary chamber 120 with the second barrier 122 in the closed configuration and enables the object to be removed via the aperture provided by the adjustment of the first barrier 121 to the open configuration. Consequently it is to be appreciated that the moveable means 228 does not need to occupy a position substantially the same distance (or further) from the second barrier 122 as the edge of the first barrier 121 that is furthest from the second barrier 122 when the first barrier 121 is adjusted to the open configuration. In some examples, the moveable means 228 is positioned proximate the second barrier 122 and acts as a secondary seal for the primary chamber 110 (where the second barrier 122 is considered the primary seal) when the second barrier 122 is adjusted to the open configuration such that the object abuts the moveable platform 228A as it exits the primary chamber 110 (e.g., under gravity). The moveable means 228 is then moved away from the second barrier 122 to the aforementioned position which it occupies when the first barrier 121 is adjusted to the open configuration. In such a manner the object is moved into the secondary chamber 120 in a controlled manner.

Upon the adjustment of the first barrier 121 to the closed configuration after the object has been removed from the secondary chamber 120 (to the external surroundings 130) the moveable means 228 is moved towards the second barrier 122. The air that has entered the secondary chamber 120 from the external surroundings 130 is urged towards the first one-way valve 227 (disposed proximate the second barrier 122) and is therefore expelled from the secondary chamber 120 via the first one-way valve 227. The moveable means 228 acts like a piston.

In some examples the secondary chamber 120 comprises a second valve disposed in the wall of the secondary chamber 120. In some examples the second valve is disposed proximate the end of the secondary chamber 120 furthest from the second barrier 122 in the direction along which the moveable means 228 moves. In some examples the second valve is disposed proximate the position which the moveable means 228 occupies when the first barrier 121 is adjusted to the open configuration or proximate the edge of the first barrier 121 that is furthest from the second barrier 122. In some example the second valve is a second one-way valve (e.g., a reed valve). The second one-way valve is configured to enable fluid (e.g., gas) to flow from inside the secondary chamber 120 to the external surroundings 130 but prevent fluid from flowing from the external surroundings 130 to inside the secondary chamber 120. Alternatively the second valve may enable fluid to flow in both directions between the inside of the secondary chamber 120 and the external surroundings 130 thus avoiding the creation of high or low pressure in the section of the secondary chamber 120 behind the moveable means 228 (where the term ‘behind’ is relative to the position of the second barrier 122). In either case as the moveable means 228 moves away from the second barrier 122 and towards the second valve, fluid is urged towards the second valve and is therefore expelled from the secondary chamber 120 via the second valve.

Although in the foregoing the first valve 227 and the second valve are described as being disposed in the wall of the secondary chamber 120, it is to be appreciated that in some examples the first valve 227 and the second valve are integrated with the first barrier 121 rather than the walls of the secondary chamber 120. Furthermore, although in the foregoing the movable platform 228A is described as extending substantially across a cross section of the secondary chamber 120 parallel to the second barrier 122 and movable towards and away from the second barrier 122, it is to be appreciated that in some examples the movable platform 228A extends substantially across a cross section of the secondary chamber 120 parallel to the first barrier 121 and movable towards and away from the first barrier 121.

FIG. 3A schematically illustrates an example of a cross-section of the secondary chamber 120 in which the second barrier 122 is adjustable between the open configuration and the closed configuration in response to user input to a means 323 for manually adjusting the second barrier 122. For example the second barrier 122 may be manually adjusted between the open configuration and the closed configuration using an external lever. The lever may be configured to rotate the second barrier 122 to open or close an aperture between the primary chamber 110 and the secondary chamber 120 (e.g., like a hinged door or gate). Alternatively the lever may be configured to retract the second barrier 122 into a slot in a wall of the secondary chamber 120 or extend the second barrier 122 from the slot across the aperture between the primary chamber 110 and the secondary chamber 120 (e.g., like a sliding door). In some examples an external pullable handle is operationally coupled to the second barrier 122 such that pulling the pullable handle away from the slot retracts the second barrier 122 in into the slot in the wall of the secondary chamber 120. The pullable handle may be pushed towards the slot to extend the second barrier 122 from the slot across the aperture between the primary chamber 110 and the secondary chamber 120. It is to be appreciated that any number or combination of intervening elements can exist (including no intervening elements) between the pullable handle and the second barrier 122.

In another example the timing of the opening and closing of the second barrier 122 is controlled by the user but the adjustment of the second barrier 122 between the open configuration and the closed configuration is controlled by one or more actuators. For example, the user may press a button to initiate the adjustment and in response, the one or more actuators may adjust the configuration of the second barrier 122. In some examples the button is disposed on an external surface of the portable low-temperature storage device 100.

FIG. 3B schematically illustrates an example of a cross-section of the secondary chamber 120 in which the second barrier 122 is automatically adjusted between the open configuration and the closed configuration. A sensor 325A (e.g., a proximity sensor or contact sensor or camera) is provided which is configured to detect the presence of an object in the secondary chamber 120. More than one sensor 325A may be provided. In some examples, in response to detection of an object in the secondary chamber 120, the sensor 325A provides an input signal to a controller 324. The controller 324 provides an output signal to one or more actuators 326. The one or more actuators 326 are configured to adjust the second barrier 122 and/or first barrier 121 between the open configuration and the closed configuration. Further sensors 325B, 325C are configured to provide further input signals to the controller 324 indicative of the current configuration of the first barrier 121 and the second barrier 122.

If the first barrier 121 is in the open configuration when an object is first detected in the secondary chamber 120, the controller determines that the object is being loaded into the portable low-temperature storage device 100. The first barrier 121 is adjusted to the closed configuration. This adjustment may be manually performed by a user or may be automatically performed by the one or more actuators 326 in response to an output signal from the controller 324. Subsequently the second barrier 122 is adjusted to the open configuration to permit conveyance of the object from the secondary chamber 120 into the primary chamber 110. The second barrier 122 is adjusted automatically by the one or more actuators 326 in response to an output signal from the controller 324. This output signal is provided once the first barrier 121 is detected to be in the closed configuration. Alternatively, if the adjustment of the first barrier 121 is automatically performed, the second barrier 122 may be adjusted after a pre-determined period of time. The predetermined period of time is equal to or longer than the time required to adjust the first barrier 121. In a still further example, where the air in the secondary chamber 120 is at least partially removed, the second barrier 122 is, in some examples, only adjusted once the air removal process is complete. The completion of the air removal process does not require all air to be removed from the secondary chamber 120.

If the second barrier 122 is in the open configuration when an object is first detected in the secondary chamber 120, the controller 324 determines that the object is being dispensed from the portable low-temperature storage device 100. The second barrier 122 is automatically adjusted to the closed configuration by the one or more actuators 326 in response to an output signal from the controller 324 to seal the primary chamber 110 against the secondary chamber 120. In some examples an indication that the second barrier 122 is in the closed configuration is provided to a user. The indication may be, for example, a visual or audio alert.

In some examples, when no object is detected in the secondary chamber 120 and the first barrier 121 is in the closed configuration, the second barrier 122 is held in the open configuration. The first barrier 121 may be locked in the closed configuration while the second barrier 122 is in the open configuration. The first barrier 121 may be unlocked once the second barrier 122 is closed either, for example, manually or automatically in response to detection of an object in the secondary chamber 120. A means 323 for manually adjusting the second barrier 122 is, in some examples, provided in addition to the controller 324 which enables automatic adjustment.

In some other examples the second barrier 122 is held in the closed configuration when no object is detected in the secondary chamber 120 and the second barrier 122 is adjusted to the open configuration when an object is detected to be proximate the primary chamber 110 facing side of the second barrier 122.

In still other examples the first barrier 121 is held in the closed configuration by default and is adjusted to the open configuration when an object is detected to be proximate the external surroundings 130 facing side of the first barrier 121. In some examples the portable low-temperature storage device 100 comprises a receptacle configured as a funnel to convey, by gravity, the temperature-sensitive pharmaceutical products toward the first barrier 121 and into a queue. In this way, a plurality of temperature-sensitive pharmaceutical products may be automatically loaded into the primary chamber 110 via the secondary chamber 120 even in instances when not all of the plurality of temperature-sensitive pharmaceutical products may be received into the secondary chamber 120 (due to the sizing of the secondary chamber 120) at one time. In some examples, the receptacle is formed by an upper surface of the portable low-temperature storage device 100.

Although FIG. 1 illustrates an example of the portable low-temperature storage device 100 in which access to the primary chamber 110 is solely via secondary chamber 120, in other examples, such as those illustrated in FIGS. 4 and 5, this may not be the case.

FIG. 4 schematically illustrates an example of a cross-section of a portable low-temperature storage device 100 like that of FIG. 1 but which further comprises a third barrier 440 configured to, in an open configuration, provide access from external surroundings 130 of the portable low-temperature storage device 100 to inside the primary chamber 110 and, in a closed configuration, prevent access from external surroundings 130 of the portable low-temperature storage device 100 to inside the primary chamber 110. In some examples the secondary chamber 120 and the third barrier 440 are disposed on opposing sides of the primary chamber 110. Access to the primary chamber 110 via the secondary chamber 120 is for one of loading an object into or dispensing an object from the primary chamber 110. Access to the primary chamber 110 via the third barrier 440 is for the other one of loading an object into or dispensing an object from the primary chamber 110.

The third barrier 440 is, in some examples, relatively larger than the first barrier 121 or secondary barrier. In some examples where an object (e.g., the temperature-sensitive pharmaceutical product) intended to be stored in the primary chamber 110 is a vial of vaccine, the secondary chamber 120 is sized to receive just one vial. The first barrier 121 and second barrier 122 have dimensions that are greater than the diameter of a standard vaccine vial but less than twice the diameter of a standard vaccine vial. The third barrier 440 has dimensions greater than twice the diameter of a standard vaccine vial. Vials of vaccine can therefore be loaded or dispensed quicker and more efficiently via the third barrier 440 than via the secondary chamber 120.

In some examples the secondary chamber 120 enables both loading and dispensing and the third barrier 440 is provided to enable quicker and more efficient loading or dispensing which may be employed where, for example, the loading or dispensing can be performed in a temperature-controlled environment such as, for example, a coolroom (e.g., refrigerated storeroom).

FIG. 5 schematically illustrates an example of a cross-section of a portable low-temperature storage device 100 like that of FIG. 1 but which further comprises a further secondary chamber 550. The further secondary chamber 550 comprises a fourth barrier 551 and a fifth barrier 552. The fourth barrier 551 is configured to, in an open configuration, provide access from external surroundings 130 of the portable low-temperature storage device 100 to inside the further secondary chamber 550 and, in a closed configuration, prevent access from external surroundings 130 of the portable low-temperature storage device 100 to inside the further secondary chamber 550. The fifth barrier 552 is configured to, in an open configuration, provide access from the further secondary chamber 550 to the primary chamber 110 and, in a closed configuration, prevent access from the further secondary chamber 550 to the primary chamber 110. It is to be appreciated that features described in the foregoing in relation to the secondary chamber 120 may also apply to the further secondary chamber 550.

Access to the primary chamber 110 via the secondary chamber 120 is for one of loading or dispensing the temperature-sensitive pharmaceutical product and access to the primary chamber 110 via the further secondary chamber 550 is for the other of dispensing or loading the temperature-sensitive pharmaceutical product. In some examples the secondary chamber 120 and the further secondary chamber 550 are disposed on opposing sides of the primary chamber 110.

In some examples, such as FIGS. 1, 4, and 5, the secondary chamber 120 is formed integrally with the primary chamber 110. The further secondary chamber 550 illustrated in FIG. 4 may also be formed integrally with the primary chamber 110.

The primary chamber 110 is insulated from the external surroundings 130 of the portable low-temperature storage device 100 (e.g., the environment). For example, the primary chamber 110 may be constructed using at least a layer of an insulating material, (e.g., polystyrene). In some examples the secondary chamber 120 and, if provided, the further secondary chamber 550 are also insulated from the external surroundings 130 of the portable low-temperature storage device 100. In some examples the first barrier 121 and the second barrier 122 and, if provided, the third barrier 440, fourth barrier 551, and fifth barrier 552 provide, in the closed configuration, thermal isolation between the air masses they separate. For example, in the closed configuration, the first barrier 121 thermally isolates the secondary chamber 120 from the environment and, in the closed configuration, the second barrier 122 thermally isolates the primary chamber 110 from the secondary chamber 120.

FIG. 6 schematically illustrates an example of a cross-section of the primary chamber 110. The primary chamber 110 comprises one or more storage compartments 660 for one or more temperature-sensitive pharmaceutical products. In some examples where the temperature-sensitive pharmaceutical product intended to be stored in the primary chamber 110 is a vial of vaccine, each storage compartment 660 is sized to receive a single vial. As such the vials of vaccine can be securely stored so that when the portable low-temperature storage device 100 is in transit, the movement of vials is constrained so as to reduce damage to said vials.

The primary chamber 110 comprises a first conveyance means 671 for conveying a temperature-sensitive pharmaceutical product to a storage compartment 660. The first conveyance means 671 is configured to convey the temperature-sensitive pharmaceutical product from the entry point into the primary chamber 110 (e.g., the aperture formed between the secondary chamber 120 and the primary chamber 110 when the second barrier 122 is in the open configuration) to a storage compartment 660. The first conveyance means 671 is adjustable such that subsequently loaded temperature-sensitive pharmaceutical products are conveyed to different storage compartments 660.

In some examples each storage compartment 660 is provided with a sensor (not shown) configured to detect the presence of an object within the storage compartment 660. Each sensor is configured to provide an input signal to the controller 324. The controller 324 determines when all the storage compartments 660 have been filled based on the input signals from these sensors. In response, the controller 324 controls one or both of the first barrier 121 and second barrier 122, or the third barrier 440, or one or both of the fourth barrier 551 and fifth barrier 552, as the case may be, such that they are locked in the closed configuration to prevent the loading of further temperature-sensitive pharmaceutical products.

In some examples the first conveyance means 671 comprises a belt conveyor system comprising a conveyor belt which carries the temperature-sensitive pharmaceutical product from the entry point into the primary chamber 110 to a storage compartment 660. In this example the storage compartments 660 are arranged in a circle. The belt conveyor system is rotated about an axis 680 relative to the storage compartments 660 to align the conveyor belt with each storage compartment 660 in turn. In some examples the belt conveyor system is rotatable about the axis 680 relative to the primary chamber 110 and the storage compartments 660 remain in a fixed position within the primary chamber 110. In other examples the storage compartments 660 are comprised in a rotatable structure within the primary chamber 110 which is rotatable about the axis 680 relative to the primary chamber 110.

The primary chamber 110 also comprises a second conveyance means 672 for conveying a temperature-sensitive pharmaceutical product from a storage compartment 660. The second conveyance means 672 is configured to convey the temperature-sensitive pharmaceutical product from a storage compartment 660 to the exit point from the primary chamber 110 (e.g., the second barrier 122). The second conveyance means 672 is adjustable such that temperature-sensitive pharmaceutical products stored in different storage compartments 660 may be conveyed to the exit point one at a time. Each temperature-sensitive pharmaceutical product may therefore be dispensed when required while the other temperature-sensitive pharmaceutical products are retained within the primary chamber 110 and thus maintained within the allowable temperature range.

In some examples the storage compartments 660 each comprise a barrier (not shown) configurable between an open configuration and a closed configuration. The open configuration enables an object to be received into or removed from the storage compartment 660 and the closed configuration prevents an object from being received into or removed from the storage compartment 660.

In some examples where the secondary chamber 120 provides the only access to the primary chamber 110 and thus the entry point is also the exit point, the second conveyance means 672 is the first conveyance means 671.

In some portable low-temperature storage devices 100 (e.g., those having different entry and exit points to/from the primary chamber 110) each storage compartment 660 comprises a pair of opposing barriers. An upper barrier is held in the open configuration during loading. In some examples, once an object is detected within the storage compartment 660 the upper barrier is adjusted to the closed configuration. Alternatively the upper barrier is adjusted between the open and closed configurations in response to alignment of the first conveyance means 671 with the storage compartment 660. During dispensing a lower barrier is adjusted to the open configuration.

In some examples the second conveyance means 672 is separate from the first conveyance means 671 but comprises the same type of underlying mechanism as the first conveyance means 671. For example, the second conveyance means 672 may also comprises a belt conveyor system comprising a conveyor belt. In the second conveyance means 672, however, the conveyor belt is configured to carry the temperature-sensitive pharmaceutical product from a storage compartment 660 to the exit point from the primary chamber 110. In this example the lower barrier of each storage compartment 660 is only adjusted to the open configuration when the conveyor belt is aligned with the respective storage compartment 660. This may be achieved by use of sensors and the controller 324 or by a mechanical locking system comprising, for example, cams and gears associated with each storage compartment 660 which are actuated by contact with components of the second conveyance means 672 upon said alignment.

The first and second conveyance means 671, 672 may alternatively be angled slides which utilise gravity to convey the temperature-sensitive pharmaceutical product from the entry point into the primary chamber 110 to a storage compartment 660 and from a storage compartment 660 to the exit point from the primary chamber 110 respectively but otherwise operate as per the belt conveyor system described in the preceding paragraphs. As a further alternative one or more claw machine systems may be used to convey the temperature-sensitive pharmaceutical product from the entry point into the primary chamber 110 to a storage compartment 660 and from a storage compartment 660 to the exit point from the primary chamber 110. The claw machine system comprises a claw which is adjustable between a closed configuration in which it is configured to grip the temperature-sensitive pharmaceutical product and an open configuration in which it is configured to release or not grip the product. The position of the claw within the primary chamber 100 is adjustable.

The primary chamber 110 is configured to be maintained at a temperature within an allowable temperature range (e.g., between 2° C. and 8° C. for vaccines). The primary chamber 110 comprises sensors (not shown) configured to monitor the temperature within the primary chamber 110. Once the temperature within the primary chamber 110 reaches a predetermined upper or lower threshold value, a cooler 690 is controlled to increase or decrease cooling respectively. The predetermine threshold values may be the same as the limits of the allowable temperature range or may be values within the allowable temperature range (e.g., 3° C. and 7° C. for vaccines).

The cooler 690, in some examples, comprises a thermoelectric cooler (e.g., one or more Peltier cooling chips). Once the temperature in the primary chamber 110 reaches the predetermined upper or lower threshold values, the current drawn by the thermoelectric cooler is adjusted. In addition, in some examples, the cooler 690 further comprises one or more fans configured to provide heat extraction from the primary chamber 110 and/or improve cold air circulation within the primary chamber 110. The fans are also controlled in response to the temperature in the primary chamber 110 reaching the predetermined upper or lower threshold values.

In some examples a heater (not shown) is also provided within the primary chamber 110 for use when the temperature of the primary chamber 110 reaches the predetermined lower threshold value and is decreasing above a threshold rate. For example, instead of merely decreasing the cooling effect provided by the cooler 690 when the temperature in the primary chamber 110 passes through a lower threshold value, a heater is additionally used to counter the falling temperature if the temperature is rapidly falling.

Although the secondary chamber 120 has be described as being integral with the primary chamber 110 and the portable low-temperature storage device 100, in some examples, the secondary chamber 120, including the first barrier 121 and the second barrier 122, may be configured as a separate container which can be coupled to and decouple from the portable low-temperature storage device 100. The secondary chamber 120 is not integral with the portable low-temperature storage device 100 and can be removed from the portable low-temperature storage device 100. The secondary chamber 120, in this example, is an independent apparatus which is configured to fit with the portable low-temperature storage device 100.

As a separate container the secondary chamber 120 may be filled with the objects by the manufacturers or suppliers of said objects. The manufacturer or supplier adjusts the first barrier 121 to an open configuration to gain access to the interior of the container (secondary chamber 120) in order to add the objects to the container. The second barrier 122 remains in a closed configuration. The secondary chamber 120, as a separate container, may then be transported with in a temperature controlled environment to a local distribution centre at which the objects are loaded into the portable low-temperature storage device 100 for delivery to a final destination by coupling the secondary chamber to the portable low-temperature storage device 100 and adjusting the second barrier 122 to an open configuration whilst the first barrier 121 is maintained in the closed configuration.

FIG. 7 illustrates an example of the aforementioned separate container 700. The first barrier 121 is configured as a lid 721. The container 700 comprises a plurality of compartments 720A-C configured to store and separate objects (e.g., temperature sensitive pharmaceutical products). Although FIG. 7 shows the container 700 as comprising three compartments it is to be appreciated that this is merely an example and the number of compartments comprised in the container may be less than or greater than three. In this example, the second barrier 122 is configured as one or more adjustable barriers 722A-C which provide one of the walls to each compartment 720A-C (i.e., a floor of each compartment). Adjusting the one or more adjustable barriers 722A-C from a closed configuration to an open configuration removes the floor of each compartment 720A-C and permits the objects to drop, under gravity, out of the container 700 into the primary chamber 110 of the portable low-temperature storage device 100.

The one or more adjustable barriers 722A-C may be adjusted between a closed configuration and an open configuration either manually or automatically. In some examples the one or more adjustable barriers 722A-C are independently adjustable between a closed configuration and an open configuration. In other examples the one or more adjustable barriers 722A-C are adjustable simultaneously.

In some examples the separate container 700 may be provided in addition to the secondary chamber 120 which, in this example, forms an integral part of the portable low-temperature storage device 100. It is to be appreciated that the separate container 700 in this example may not comprise a lid 721 or a plurality of compartments 720A-C and may only comprise a single adjustable barrier 722 forming a floor of the container 700. Adjusting the one or more adjustable barriers 722A-C from a closed configuration to an open configuration removes the floor of the container 700 and permits the objects to drop, under gravity, out of the container 700.

When the objects are transferred from the container 700 to the portable low-temperature storage device 100, the container 700 is aligned such that the at least one barrier 710, in a closed configuration, is positioned between the objects and the secondary chamber 120.

In some examples, the container 700 is positioned external to the secondary chamber 120. The objects may be dropped into the aforementioned receptacle and thus be automatically loaded into the primary chamber 110 via the secondary chamber 120 as previously described.

Alternatively, in some examples, the secondary chamber 120 may be sized to receive therein the container 700 but configured to prevent passage of the container 700 through the secondary chamber 120 into the primary chamber 110. For example, the secondary chamber 120 may comprise a shelf upon which the container 700 is placed. Once the container 700 is disposed within the secondary chamber 120, the first barrier 121 is adjusted to a closed configuration. The at least one adjustable barrier 710 of the container 700 is opened and the objects carried by the container 700 are released. In some examples the secondary chamber 120 may be configured as a funnel to convey, by gravity, the objects toward the second barrier 122 and into a queue.

In still other examples the first barrier 121 is provided by the at least one adjustable barrier 710 of the container 700.

In some examples, the portable low-temperature storage device 100 comprises a battery (not shown) for powering its electronic components (e.g., the controller, sensors, actuators, cooler, etc.). In some examples the battery is a rechargeable battery. In some examples the portable low-temperature storage device 100 is fitted with one or more of a solar panel, a wind turbine, a vibration-powered generator (e.g., an electromagnetic generator or a piezoelectric generator), a sound-power generator, etc. for generating electrical energy to recharge the rechargeable battery. In some examples, these generators may directly power the portable low-temperature storage device 100 rather than recharging the battery. The temperature-sensitive pharmaceutical products may therefore be maintained within an allowable temperature range for a greater period of time, thus facilitating delivery to more remote geographical locations.

In some examples the portable low-temperature storage device 100 comprises means for attachment to a drone (e.g., clips, straps, hooks, loops, etc.). The mass of the portable low-temperature storage device 100 is between 1 kg and 3 kg. Carrying this mass is within the capabilities of numerous drone models that are presently manufactured and available on the market. In some examples the mass of the portable low-temperature storage device may be greater than 3 kg provided the loaded mass of the portable low-temperature storage device 100 is less than the limit that may be carried by drones, if drone transportation is desirable. In some examples the mass of the portable low-temperature storage device 100 may be less than 1 kg. The use of a drone may, in some circumstances, significantly expedite the delivery of the temperature-sensitive pharmaceutical products to their destination and/or enable delivery to previously inaccessible geographical locations (or at least geographical locations which it was unfeasible to deliver to previously). In some examples, the portable low-temperature storage device 100 can be charged or powered via solar panels or energy sources providers available on the drone.

Implementation of a controller 324 may be as controller circuitry. The controller 324 may be implemented in hardware alone, have certain aspects in software including firmware alone or can be a combination of hardware and software (including firmware).

As illustrated in FIG. 8 the controller 324 may be implemented using instructions that enable hardware functionality, for example, by using executable instructions of a computer program 829 in a general-purpose or special-purpose processor 827 that may be stored on a computer readable storage medium (disk, memory etc) to be executed by such a processor 827.

The processor 827 is configured to read from and write to the memory 828. The processor 827 may also comprise an output interface via which data and/or commands are output by the processor 827 and an input interface via which data and/or commands are input to the processor 827.

The memory 828 stores a computer program 829 comprising computer program instructions (computer program code) that controls the operation of the portable low-temperature storage device 100 when loaded into the processor 827. The computer program instructions, of the computer program 829, provide the logic and routines that enables the adjustment of the barriers in the portable low-temperature storage device 100, for example. The processor 827 by reading the memory 828 is able to load and execute the computer program 829.

Although the memory 828 is illustrated as a single component/circuitry it may be implemented as one or more separate components/circuitry some or all of which may be integrated/removable and/or may provide permanent/semi-permanent/dynamic/cached storage.

Although the processor 827 is illustrated as a single component/circuitry it may be implemented as one or more separate components/circuitry some or all of which may be integrated/removable. The processor 827 may be a single core or multi-core processor.

The term ‘couple’ and its derivatives are used in this document to mean directly coupled or indirectly coupled. It should be appreciated that any number or combination of intervening components can exist (including no intervening components). The term ‘decouple’ and its derivatives are used in this document to mean removable by a user without specific tools.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

For example, although in the foregoing description of the figures, reference is made to a portable low-temperature storage device for storing temperature-sensitive pharmaceutical products, it is to be appreciated that the portable low-temperature storage device may be used for storing other objects. For example, the portable low-temperature storage device may be used to store other temperature sensitive products such as semi-conductors, chemicals, compounds, polymers, electronic components etc.

Moreover, it is to be appreciated that the underlying structure provides the advantage of reducing heat exchange between a primary chamber of a portable storage device and the external surroundings (e.g., the environment). While the foregoing description is concerned with keeping objects stored within the primary chamber cool during transportation in hot environments, the underlying structure is equally applicable for keeping objects stored within the primary chamber warm during transportation in relatively cooler environments. For example, the underlying structure described in the foregoing may be used by fast food delivery services to maintain a customer's order at a desirable temperature.

Therefore in a further aspect of the present disclosure there is provided a portable high-temperature storage device for storing at least one temperature-sensitive object. The portable high-temperature storage device comprises a primary chamber configured to store at least one temperature-sensitive object and a secondary chamber. The secondary chamber comprises a first barrier and a second barrier. The first barrier is configured to, in an open configuration, provide access from external surroundings of the portable temperature-stable storage device to inside the secondary chamber and, in a closed configuration, prevent access from external surroundings of the portable temperature-stable storage device to inside the secondary chamber. The second barrier is configured to, in an open configuration, provide access from the secondary chamber to the primary chamber and, in a closed configuration, prevent access from the secondary chamber to the primary chamber. The second barrier is adjustable between the open configuration and the closed configuration whilst the first barrier is in the closed configuration.

It is to be appreciated that the allowable temperature range may be set and adjusted by a user. In some examples, the portable temperature-stable storage device 100 comprises an input means (not shown) configured to enable a user to set the allowable temperature range. Said input means may be in the form of a dial or a touch sensitive digital display or buttons disposed on, for example, an outer surface of the portable temperature-stable storage device 100.

As a further example, the portable temperature-stable storage device 100 may comprise a plurality of primary, secondary, and/or further secondary chambers 110, 120, 550. For example, the portable temperature-stable storage device 100 may comprise at least four primary chambers 110 and at least four secondary chambers 120 for storing four different types of object.

Additionally, in some examples the portable temperature stable device 100 may comprise a window (not shown) to enable a user to view the objects when they are inside the portable temperature stable device 100. For example, a window may be provided in the wall of the primary chamber 110. This enables a user to see the objects stored in the primary chamber 110 and therefore select which object to dispense from the portable temperature stable device 100. In some examples a window may additionally or alternatively be provided in the wall of the secondary chamber 120.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-25. (canceled)

26. A portable temperature-stable storage device for at least one temperature-sensitive object, the portable temperature-stable storage device comprising:
a primary chamber configured to store the at least one temperature-sensitive object; and
a secondary chamber comprising:
a first barrier configured to, in an open configuration, provide access from external surroundings of the portable temperature-stable storage device to inside the secondary chamber and, in a closed configuration, prevent access from external surroundings of the portable temperature-stable storage device to inside the secondary chamber, and
a second barrier configured to, in an open configuration, provide access from the secondary chamber to the primary chamber and, in a closed configuration, prevent access from the secondary chamber to the primary chamber,
wherein the second barrier is adjustable between the open configuration and the closed configuration whilst the first barrier is in the closed configuration.

27. The portable temperature-stable storage device as claimed in claim 1, configured to maintain a substantially stable temperature in the primary chamber during transportation.

28. The portable temperature-stable storage device as claimed in claim 1, further comprising a cooler and at least one of a battery and electrical energy generator, for powering at least the cooler.

29. The portable temperature-stable storage device as claimed in claim 1, wherein access to the primary chamber via the secondary chamber is for conveyance of the at least one temperature-sensitive object between the external surroundings of the portable temperature-stable storage device and the primary chamber.

30. The portable temperature-stable storage device as claimed in claim 1, further comprising a fluid removal component configured to remove at least some fluid from at least one of the secondary chamber or the primary chamber.

31. The portable temperature-stable storage device as claimed in claim 5, wherein the fluid removal component comprises:
at least one valve disposed between the secondary chamber and the external surroundings; and
a moveable component, disposed within the secondary chamber, configured such that movement of the moveable component with respect to the at least one valve causes transfer of fluid through the at least one valve.

32. The portable temperature-stable storage device as claimed in claim 6, wherein the at least one valve is a one-way valve configured to enable fluid to flow from inside the secondary chamber to the external surroundings and prevent fluid from flowing from the external surroundings to inside the secondary chamber, wherein the at least one valve is disposed adjacent the second barrier, wherein the moveable component comprises a moveable platform which extends substantially across a cross section of the secondary chamber parallel to the second barrier, and wherein the moveable component forms a moveable fluid-tight seal with walls of the secondary chamber.

33. The portable temperature-stable storage device as claimed in claim 1, wherein the second barrier is manually adjustable between the open configuration and the closed configuration.

34. The portable temperature-stable storage device as claimed in claim 1, wherein access to the primary chamber is solely via the secondary chamber.

35. The portable temperature-stable storage device as claimed in claim 1, further comprising a third barrier configured to, in an open configuration, provide access from external surroundings of the portable temperature-stable storage device to inside the primary chamber and, in a closed configuration, prevent access from external surroundings of the portable temperature-stable storage device to inside the primary chamber.

36. The portable temperature-stable storage device as claimed in claim 1, further comprising a further secondary chamber comprising:
a fourth barrier configured to, in an open configuration, provide access from external surroundings of the portable temperature-stable storage device to inside the further secondary chamber and, in a closed configuration, prevent access from external surroundings of the portable temperature-stable storage device to inside the further secondary chamber; and
a fifth barrier configured to, in an open configuration, provide access from the further secondary chamber to the primary chamber and, in a closed configuration, prevent access from the further secondary chamber to the primary chamber,
wherein access to the primary chamber via the secondary chamber is for one of loading or dispensing the at least one temperature-sensitive object and access to the primary chamber via the further secondary chamber is for one or more of dispensing or loading the at least one temperature-sensitive object.

37. The portable temperature-stable storage device as claimed in claim 1, wherein the primary chamber comprises one or more storage compartments for the at least one temperature-sensitive object.

38. The portable temperature-stable storage device as claimed in claim 1, wherein the primary chamber comprises a component for conveying the at least one temperature-sensitive object to and/or from a storage compartment.

39. The portable temperature-stable storage device as claimed in claim 1, wherein the primary chamber is configured to be maintained within an allowable temperature range.

40. The portable temperature-stable storage device as claimed in claim 1, wherein the secondary chamber is formed integrally with the primary chamber.

41. The portable temperature-stable storage device as claimed in claim 1, wherein the secondary chamber, comprising the first barrier and the second barrier, is configured to decouple from the portable temperature-stable storage device.

42. The portable temperature-stable storage device as claimed in claim 16, wherein the secondary chamber comprises a plurality of compartments each configured to store at least one temperature-sensitive object.

43. The portable temperature-stable storage device as claimed in claim 1, wherein the portable temperature-stable storage device is a portable low-temperature storage device.

44. The portable temperature-stable storage device as claimed in claim 1, wherein the portable temperature-stable storage device is for storing at least one temperature-sensitive pharmaceutical product.

45. A system, comprising:
a portable temperature-stable storage device for at least one temperature-sensitive object, the portable temperature-stable storage device comprising:
a primary chamber configured to store the at least one temperature-sensitive object; and
a secondary chamber comprising:
a first barrier configured to, in an open configuration, provide access from external surroundings of the portable temperature-stable storage device to inside the secondary chamber and, in a closed configuration, prevent access from external surroundings of the portable temperature-stable storage device to inside the secondary chamber, and
a second barrier configured to, in an open configuration, provide access from the secondary chamber to the primary chamber and, in a closed configuration, prevent access from the secondary chamber to the primary chamber,
wherein the second barrier is adjustable between the open configuration and the closed configuration whilst the first barrier is in the closed configuration; and
a container configured to store at least one temperature-sensitive object wherein the container comprises one or more adjustable barriers configured to, in a closed configuration, separate the at least one temperature-sensitive object and the secondary chamber of the portable temperature-stable storage device and, in an open configuration, release the temperature-sensitive objects from the container.
